(19) United States
(12) Patent Application Publication
(10) Pub. No.: US 2025/0039990 A1
(43) Pub. Date: Jan. 30, 2025

(54) A TEMPERATURE MONITORING SYSTEM

(71) Applicant: Micromass UK Limited, Wilmslow (GB)

(72) Inventor: Richard Moulds, Wilmslow (GB)

(73) Assignee: Micromass UK Limited, Wilmslow (GB)

(21) Appl. No.: 18/717,182

(22) PCT Filed: Dec. 7, 2022
(86) PCT No.: PCT/GB2022/053108

§ 371 Date: Jun. 6, 2024

(30) Foreign Application Priority Data
Dec. 8, 2021 (GB) 2117744.9

(51) Int. Cl. H05B 1/02; G01K 7/02; H01J 49/04

(52) U.S. Cl. CPC H05B 1/0244; G01K 7/021; H01J 49/0486

(57) ABSTRACT

A temperature monitoring system (16) for use with a thermocouple (21) and a heater controller (24) to control a heater (1). The system (16) comprises a differential amplifier (17) which comprises a first input terminal (18) which is configured to connect to a first terminal (20) of the thermocouple (21) and a second input terminal (19) which is configured to connect to a second terminal (22) of the thermocouple (21). The differential amplifier (17) comprises an output terminal (23) which is configured to provide a temperature sense signal to the heater controller to control the heater (1). The system (16) further comprises a protection circuit (24) which is connected to the first input terminal (18) and the second input terminal (19). The protection circuit (24) is configured to operate in a first mode in the event that a leakage current flows into the first input terminal (18) or the second input terminal (19); and a second mode in the event that a leakage current flows out from the first input terminal (18) or the second input terminal (19), such that the protection circuit (24) controls the differential amplifier (17) to output a temperature sense signal which controls the heater (1) to operate at a temperature at or below a predetermined temperature to reduce the risk of damage being caused by the heater (1).

### FIELD

The present invention relates to a temperature monitoring system, and more particularly to a temperature monitoring system for use with a thermocouple and a heater control system in a mass spectrometry system.

### BACKGROUND

A mass spectrometer typically comprises components which operate at a high voltage and a high temperature. For example, a heater is provided to heat components which operate at a high voltage in mass spectrometry devices, such as an electrospray ionisation (ESI) device, a desorption electrospray ionisation (DESI) device or an acoustic droplet transfer line device.

FIG. 1 of the accompanying drawings shows an example of a heater 1 for use in a mass spectrometry system. The heater 1 comprises an elongate and generally-cylindrical outer jacket 2 which is heated by a heating element 3.

FIG. 2 shows a thermocouple 4 which is configured to sense the temperature of an item (not shown) which is being heated by the heater 1. The thermocouple 4 comprises a first elongate conductor 5a and a second elongate conductor 5b which extend along the length of the thermocouple 4. The first and second elongate conductors 5a, 5b are electrically connected together at one end at a connection 6. At the other end of the conductors 5a, 5b, the thermocouple 4 comprises a first terminal 7 which is provided at the free end of the first conductor 5a and a second terminal 8 which is provided at the free end of the second conductor 5b. In this example, the conductors 5a, 5b are partially enclosed within an elongate electrically insulating jacket 9. The electrically insulating jacket 9 is typically of magnesium oxide or another suitable electrically insulating and heat resistant material.

The heater 1 is provided with an electrically insulating layer 10 which surrounds the heating element 3 and electrically insulates the outer jacket 2 from the heating element 3.

When the heater 1 is in use in a mass spectrometer or an inlet device for a mass spectrometer, it is often desirable to attach the outer jacket 2 of the heater 1 to an object which is at a high voltage of several hundred volts. The electrically insulating jacket 9 of the thermocouple 4 is typically also attached to the object in order to measure the temperature of the object. The electrically insulating jacket 9 electrically insulates the conductors 5a, 5b of the thermocouple 4 from the high voltage. Consequently, the electrically insulating jacket 9 minimises the risk of the high voltage inducing a leakage current in the conductors 5a, 5b which may affect the accuracy at which the thermocouple 4 can measure the temperature of the object.

When the electrically insulating jacket 9 is functioning as intended, the risk of a leakage current in the conductors 5a, 5b is minimised. However, a problem can occur if the electrically insulating jacket 9 inadvertently becomes conductive. This can occur over time as the electrically insulating jacket 9 degrades due to being heated to high temperatures repeatedly or when the electrically insulating jacket 9 is exposed to humidity. For instance, magnesium oxide in the electrically insulating jacket 9 is inherently hygroscopic and this can result in the magnesium oxide absorbing water from the air over time and becoming electrically conductive. This can occur when the thermocouple 4 is in storage, before the thermocouple 4 is even installed in a mass spectrometry system.

If the electrically insulating jacket 9 becomes conductive, the high voltage of the object can induce a leakage current in the conductors 5a, 5b of the thermocouple 4. The leakage current raises or lowers the voltage across the conductors 5a, 5b which in turn can cause a heater control circuit which is connected to the thermocouple 4 to misread the temperature of the thermocouple 4. This can result in the heater control circuit controlling the heater 1 to operate at an incorrect temperature.

The consequence of a leakage current in the thermocouple 4 can be minimal if the leakage current is small, since the accuracy of the temperature measurement of the thermocouple 4 will be minimally affected. However, a larger leakage current will affect the accuracy of temperature measurement of the thermocouple 4 significantly, which may lead a heater control circuit to control the heater 1 to operate at a far higher temperature than intended. This may lead to catastrophic damage in the mass spectrometer and a possible fire or burn risk.

It has been proposed previously to mitigate the above-mentioned problem by providing additional insulation around the thermocouple 4. However, the additional insulation has the undesirable effect of increasing the size, complexity and cost of the thermocouple 4.

Referring now to FIG. 3 of the accompanying drawings, a conventional thermocouple measurement circuit 11 comprises a differential amplifier 12 having a non-inverting input 13 and an inverting input 14. The free ends 7, 8 of the conductors 5a, 5b of the thermocouple 4 are connected electrically to the respective non-inverting and inverting inputs 13, 14 of the differential amplifier 12. In use, the differential amplifier 12 amplifies a difference between the voltages of the first and second conductors 5a, 5b and provides an output signal via an output 15. The output signal is used to control the heater 1 to activate or deactivate the heater 1 such that the heater 1 operates at a predetermined temperature.

A resistor R1 is connected electrically between the non-inverting input 13 and a positive voltage power rail. A resistor R2 is connected electrically between the inverting input 14 and a negative voltage power rail. The resistors R1, R2 are provided in order to protect the thermocouple measurement circuit 11 from malfunctioning in the event that the thermocouple 4 goes open circuit, such that one or both of the conductors 5a, 5b becomes electrically disconnected from the differential amplifier 12. In a conventional thermocouple measurement circuit, the resistors R1, R2 are selected to be a high value, such as 1 MΩ.

While the resistors R1, R2 provide effective protection from a malfunction due to the thermocouple 3 going open circuit, the high value of the resistors R1, R2 makes the temperature monitoring system 11 susceptible to leakage currents which may be induced by the high voltage of the heater 1, as described above. For example, the high values of the resistors R1, R2 mean that small leakage currents will drive the voltage at the instrumentation input beyond its working range.

Conversely, reducing the values of the resistors R1, R2 causes a significant current to pass from one power rail to the other via the thermocouple 4. This has the undesirable effect of generating a significant voltage across the thermocouple 4, mimicking a temperature that is related to the current rather than the actual temperature of the object being measured by the thermocouple 4.

The present invention seeks to provide a temperature monitoring system which alleviates at least some of the problems outlined herein.

### BRIEF DESCRIPTION OF THE INVENTION

The present invention provides a temperature monitoring system as claimed in claim 1, an integrated circuit as claimed in claim 8, a heating apparatus as claimed in claim 9, an electrospray ionisation source as claimed in claim 11 and a mass spectrometry system as claimed in claim 12.

The present invention also provides preferred embodiments as claimed in the dependent claims.

The temperature monitoring system of an example of this disclosure provides an output signal which is always indicative of a temperature which is at or above the true temperature of a heater which is being controlled by the temperature monitoring system. This ensures that the temperature monitoring system controls the temperature of the heater at or below a predetermined safe temperature and never above the predetermined safe temperature. This minimises the risk of the temperature monitoring system controlling a heater to operate at an excessively high temperature which might otherwise cause catastrophic damage and present a burn or fire risk.

A further benefit of the temperature monitoring system of an example of this disclosure is that the temperature monitoring system is configured to change its input impedance in response to the level of current flowing into or out from the inputs of the temperature monitoring system. This makes the temperature monitoring system significantly less susceptible to leakage currents than a conventional temperature monitoring system.

For example, the temperature monitoring system of an example of this disclosure lowers the impedance between one side of the thermocouple and a low voltage (e.g. ground or another voltage within the input range of the instrumentation amplifier). The fact that at least one side of the thermocouple is low impedance to ground (or other low voltage) is why the differential inputs do not exceed the input range of the amp when high voltage leakage occurs. The fact that only one of the thermocouple inputs is low impedance to the low voltage is why the quiescent current through the thermocouple is minimised. The fact that the circuit changes this impedance with leakage magnitude allows the circuit to remain functional over a wide leakage current range. The changing impedance also allows the system to detect when temperature accuracy is becoming significantly affected whilst still allowing functional heating to take place.

A further benefit of the temperature monitoring system of an example of this disclosure is that the temperature monitoring system is configured to detect a leakage current flowing into or out from the thermocouple and to detect the level of the leakage current. This enables the temperature monitoring system to output a leakage current value to a user which can be used to warn a user that the thermocouple and/or its surrounding electrical insulation has aged or deteriorated and requires replacement.

A yet further benefit of the temperature monitoring system of an example of this disclosure is that the temperature monitoring system never disables the heater because the temperature monitoring system always controls the heater to operate at or below a safe predetermined temperature. Consequently, the heater remains functional, allowing thermocouples and heaters which are new but affected by moisture to be used safely for a period of time. This results in an additional benefit in that the heat applied by the heater may, over a period of time, drive out the moisture in the electrically insulating material, in turn reducing or eliminating the leakage current.

The temperature monitoring system of an example of this disclosure has an environmental benefit in that it minimises industrial waste by enabling thermocouples and heaters to be used safely, even when the electrical insulation between the heater and the thermocouple has partially degraded, for instance due to moisture.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a diagrammatic view of a conventional heater;

FIG. 2 is a diagrammatic view of a conventional thermocouple;

FIG. 3 is a circuit diagram of a conventional thermocouple measurement circuit;

FIG. 4 is a circuit diagram of a temperature monitoring system of an example of the present disclosure which is connected to a thermocouple, a heater control system and a heater;

FIG. 5 is a circuit diagram showing a leakage current flowing due to a positive voltage at an input of the temperature monitoring system of FIG. 4;

FIG. 6 is a circuit diagram showing a leakage current flowing due to a positive voltage at an input of the temperature monitoring system of FIG. 4;

FIG. 7 is a circuit diagram showing a leakage current flowing due to a negative voltage at an input of the temperature monitoring system of FIG. 4;

FIG. 8 is a circuit diagram showing a leakage current flowing due to a negative voltage at an input of the temperature monitoring system of FIG. 4; and

FIG. 9 is a circuit diagram showing the effect on the temperature monitoring system of FIG. 4 due to a thermocouple going open circuit.

### DETAILED DESCRIPTION OF THE DISCLOSURE

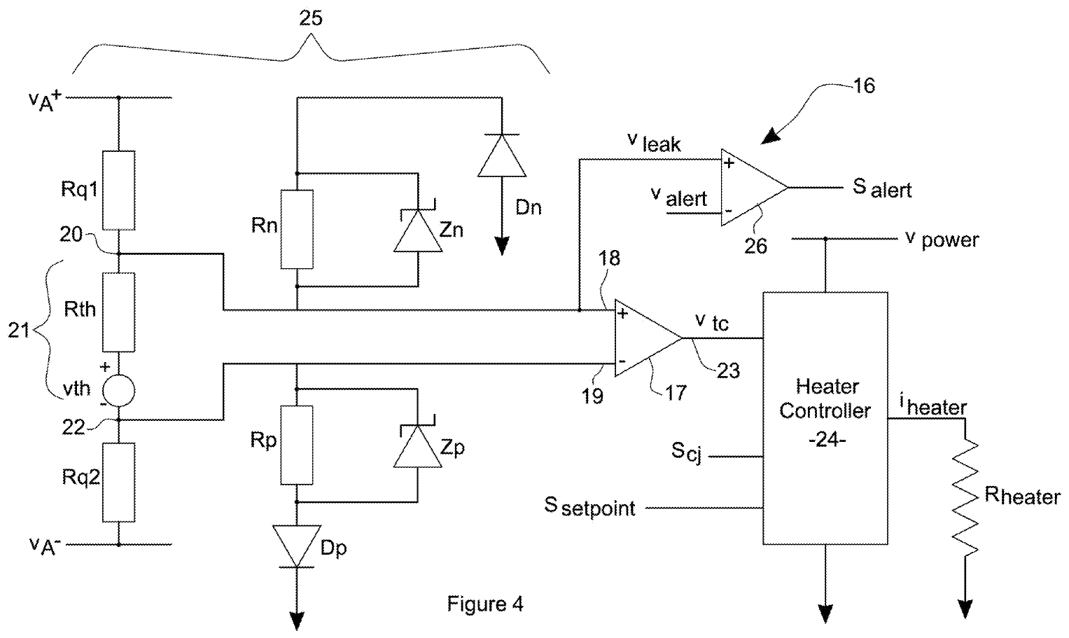

Referring now to FIG. 4 of the accompanying drawings, a temperature monitoring system 16 of an example of this disclosure comprises a differential amplifier 17 which incorporates a first input terminal 18 and a second input terminal 19. In this example, the first input terminal 18 is a non-inverting input terminal and the second input terminal is an inverting input terminal.

The first input terminal 18 is configured to connect to a first terminal 20 of a thermocouple 21 and the second input terminal 19 is configured to connect to a second terminal 22 of the thermocouple 21, as shown in FIG. 4. The thermocouple 21 is represented by a low value resistor Rth, typically of around 10Ω, and a voltage source Vth.

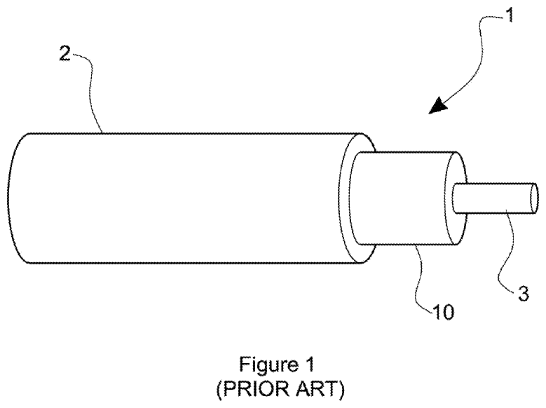

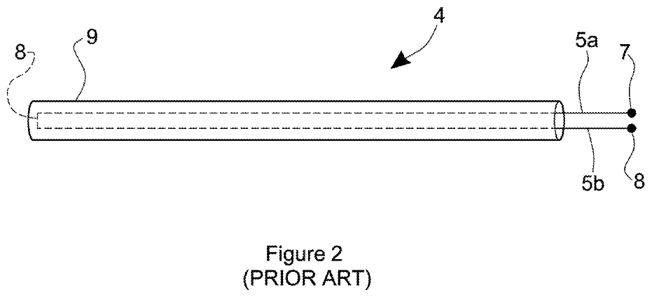

The differential amplifier 17 comprises an output terminal 23 which is configured to provide a temperature sense signal in the form of a temperature sense voltage Vtc to a heater controller 24. The heater controller 24 outputs a heater current iₕₑₐₜₑᵣ to control a heater Rₕₑₐₜₑᵣ, such as the heater 1 shown in FIG. 1.

The differential amplifier 17 is configured to generate the temperature sense signal in response to a difference between a first voltage at the first input terminal 18 and a second voltage at the second input terminal 19. The temperature sense voltage Vtc is proportional to the temperature difference between the tip of the thermocouple 4 and the cold junction of the thermocouple 4. In this example, Vtc ˜40 uV/° C. and the non-inverting “+” input terminal 18 is positive with respect to the inverting “−” input terminal 19 when the tip of the thermocouple 4 is hotter than the cold junction of the thermocouple 4.

The temperature monitoring system 16 comprises a protection circuit 25 which is connected to the first input terminal 18 and the second input terminal 19. As will be described in more detail below, the protection circuit 25 is configured to operate in a first mode in the event that a leakage current flows into the first input terminal 18 or the second input terminal 19. The protection circuit 25 is configured to operate in a second mode in the event that a leakage current flows out from the first input terminal 18 or the second input terminal 19. When the protection circuit is operating in the first mode or the second mode, the protection circuit 25 controls the differential amplifier 17 to output a temperature sense signal Vtc to the heater controller 24 which controls the heater Rₕₑₐₜₑᵣ to operate at a temperature at or below a predetermined temperature to reduce the risk of damage being caused by the heater.

The heater controller 24 measures the cold junction temperature S_{cj} of the thermocouple 4 and adds it to the temperature reported by the temperature monitoring system 16. The heater controller 24 then compares the result with a requested setpoint temperature Sₛₑₜₚₒᵢₙₜ. The control circuitry or logic in the heater controller 24 then determines if more or less power should be applied to the heater. The control circuitry will then alter the power supplied to the heater accordingly.

The protection circuit 25 comprises a first resistor Rₙ and a first diode Dₙ which are connected in series. The cathode of the first diode Dₙ is towards the positive terminal 20 of the thermocouple. A first terminal of the first diode Dₙ is connected to ground (or another voltage operating within the range of the inputs 18, 19 of the differential amplifier 17) and a second terminal of the first diode Dₙ is connected to a first terminal of the first resistor Rₙ. In this example, the first diode Dₙ is in the forward direction from ground (or another voltage operating within the range of the inputs 18, 19 of the differential amplifier 17) to the first resistor Rₙ such that the polarity of the first diode Dₙ is matched to the polarity of the first thermocouple input terminal 20. In another example, the direction of the first diode Dₙ may be reversed if the polarity of the thermocouple input terminals 20, 22 is reversed. A second terminal of the first resistor Rₙ is connected to the first input 18 of the differential amplifier 17.

The components of the protection circuit 25 which enable the protection circuit 25 to operate in the first and second modes will now be described.

The protection circuit 25 comprises a second resistor Rₚ and a second diode Dₚ. A first terminal of the second resistor Rₚ is connected to the second input 19 of the differential amplifier 17 and a second terminal of the second resistor Rₚ is connected to a first terminal of the second diode Dₚ. A second terminal of the second diode Dₚ is connected to ground (or another voltage operating within the range of the inputs 18, 19 of the differential amplifier 17). The cathode of the second diode Dₚ is towards ground.

In this example the second diode Dₚ is in the forward direction from the second resistor Rₚ to ground (or another voltage operating within the range of the inputs 18, 19 of the differential amplifier 17) such that the polarity of the second diode Dₚ is matched to the polarity of the second thermocouple input terminal 22. In another example, the direction of the second diode Dₚ may be reversed if the polarity of the thermocouple input terminals 20, 22 is reversed.

In an example of this disclosure, the protection circuit 25 is configured to operate in a third mode in the event that at least one of the first input terminal 18 or the second input terminal 19 is electrically disconnected from the thermocouple 21. When the protection circuit 25 is operating in the third mode, the protection circuit controls the differential amplifier 17 to output a temperature sense signal which controls the heater controller 24 to control the heater Rₕₑₐₜₑᵣ, such as the heater 1 shown in FIG. 1, to switch off to reduce the risk of damage being caused by the heater. In this example, the protection circuit 25 outputs a signal Vtc corresponding to very high temperature (beyond the normal operating range). The heater controller 24 will then try to cool the heater Rₕₑₐₜₑᵣ (typically by switching off the power to the heater).

The components of the protection circuit 25 which enable the protection circuit 25 to operate in the third mode will now be described.

These components comprise a third resistor R_{q1} comprising a first terminal connected to a positive voltage power rail, which in this example is a +15V power rail. A second terminal of the third resistor R_{q1} is connected to the first input terminal 18 of the differential amplifier 17. A fourth resistor R_{q2} comprises a first terminal connected to the second input terminal 19 of the differential amplifier 17. A second terminal of the fourth resistor R_{q2} is connected to ground or a negative voltage power rail, which in this example is a −15V power rail.

In other examples, the protection circuit 25 is configured to operate in the third mode if the third resistor R_{q1} is connected to a power rail of any voltage which is higher than the voltage of the power rail connected to the fourth resistor R_{q2}.

It is, however, to be appreciated that the third resistor R_{q1} and the fourth resistor R_{q2} are optional and may be omitted from the protection circuit 25 in an example of this disclosure.

In this example, the protection circuit 25 comprises a first Zener diode Zₙ which is connected in parallel with the first resistor Rₙ. The first Zener diode Zₙ is connected in the forward direction from the first input 18 of the differential amplifier 17 to the first diode Dₙ.

In this example, the protection circuit 25 comprises a second Zener diode Zₚ which is connected in parallel with the second resistor Rₚ. The second Zener diode Zₚ is connected in the forward direction from the second diode Dₚ and the second input 19 of the differential amplifier 17.

It is to be appreciated that the first and second Zener diodes Zₙ, Zₚ or the first and second diodes Dₙ, Dₚ may be omitted from the protection circuit 25 of an example of this disclosure. However, the preferred arrangement comprises both the Zener diodes Zₙ, Zₚ and the first and second diodes Dₙ, Dₚ in pairs with the resistors Rₙ, Rₚ, as shown in FIG. 4.

In an example of this disclosure, at least some and preferably all of the components of the temperature monitoring system 16 are implemented within an integrated circuit which is configured to be connected to a circuit in which a leakage current is envisaged.

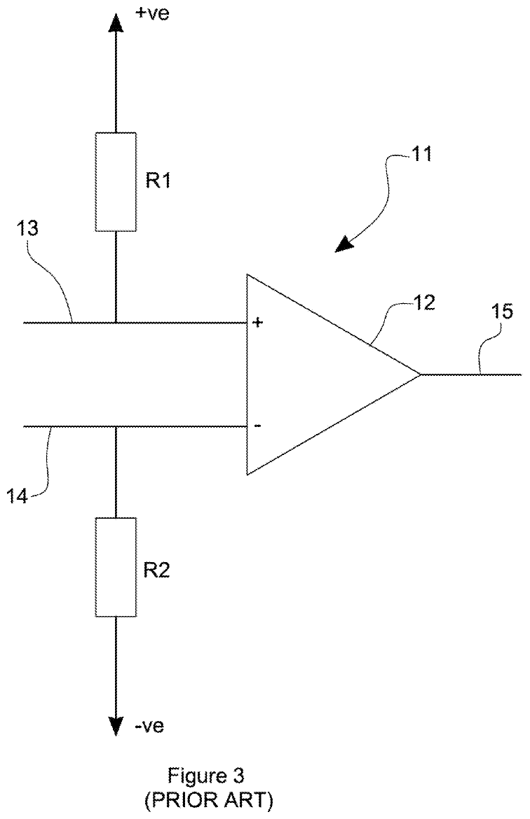

In another example of this disclosure, a heating apparatus comprises the temperature monitoring system 16, a heater such as the heater 1 shown in FIG. 1 and a thermocouple, such as the thermocouple 21 shown in FIG. 3.

In another example of this disclosure, an electrospray ionisation source comprises a heating apparatus as described above. In a further example of this disclosure a mass spectrometry system comprises a heating apparatus as described above.

In an example of this disclosure, the temperature monitoring system 16 comprises a monitoring circuit 26 which is connected to the first input terminals 18 (or alternatively the second input terminal 19) of the differential amplifier 17 to monitor the voltage Vₗₑₐₖ at the first input terminal 18. The monitoring circuit is configured to provide a monitor output signal Sₐₗₑᵣₜ which is dependent on a comparison between the voltage Vₗₑₐₖ and an alert voltage Valent. The monitor output signal Sₐₗₑᵣₜ provides an indication of whether there is a leakage current at the first or second input terminals 18, 19 and, if there is a leakage current, the value of the leakage current. This monitor output signal Sₐₗₑᵣₜ can thus be used to alert a user to a significant leakage current which may require replacement of the thermocouple or other component.

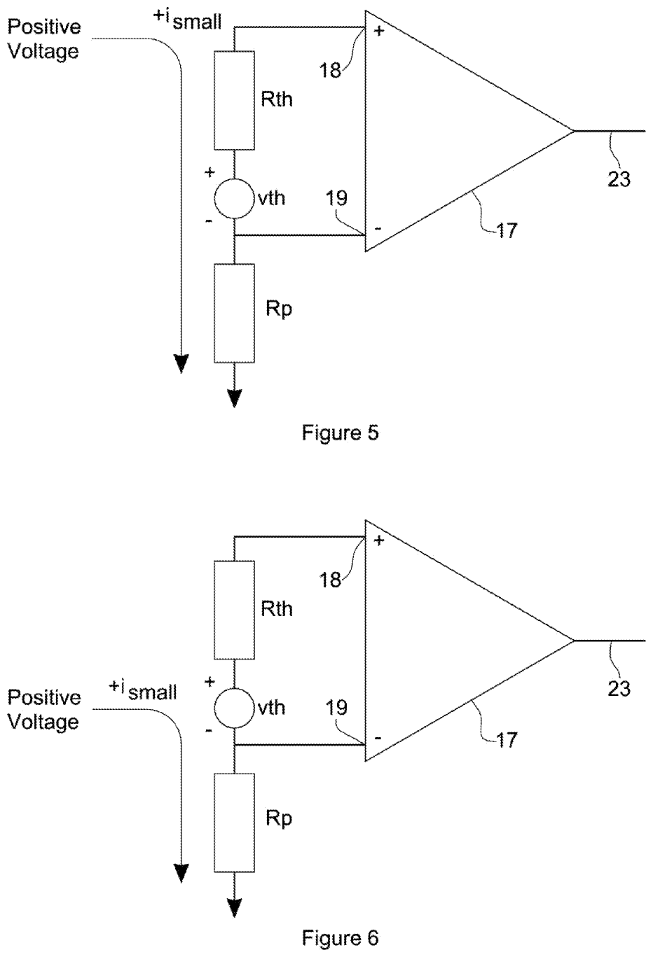

The operation of the temperature monitoring system of an example of this disclosure will now be described with reference to FIGS. 5-9 of the accompanying drawings. For clarity, the diodes Dₙ, Dₚ and the Zener diodes Zₙ, Zₚ are omitted in FIGS. 5-9.

FIG. 5 shows how the protection circuit 25 diverts a leakage current+iₛₘₐₗₗ which induces a positive voltage across the first and second input terminals 18, 19 of the differential amplifier 17. The leakage current+iₛₘₐₗₗ makes the voltage at the first input terminal 18 more positive with respect to the second input terminal 19, leading to an increased reported temperature. The leakage current+iₛₘₐₗₗ is small enough to not raise the voltage at the first or second input terminals 18, 19 to the breakdown voltages at which the first and second Zener diodes Zpn, Zₚ conduct.

The leakage current+iₛₘₐₗₗ flows through the thermocouple 21 and the second resistor Rₚ, as well as the second diode Dₚ (not shown). The effect of this positive voltage differential across the first and second input terminals 18, 19 is for the differential amplifier 17 to output a high output signal which controls a heater to operate at a temperature which is at or lower than a predetermined safe temperature.

FIG. 6 shows a similar operation to FIG. 5, but with the leakage current+iₛₘₐₗₗ flowing into the second input terminal 19. In this example, the leakage current +iₛₘₐₗₗ again produces a positive voltage at the input terminals 18, 19. The leakage current+iₛₘₐₗₗ is diverted to flow through the second resistor Rₚ, and the second diode Dₚ (not shown) to ground. The output signal produced by the differential amplifier 17 is not affected by the leakage current+iₛₘₐₗₗ.

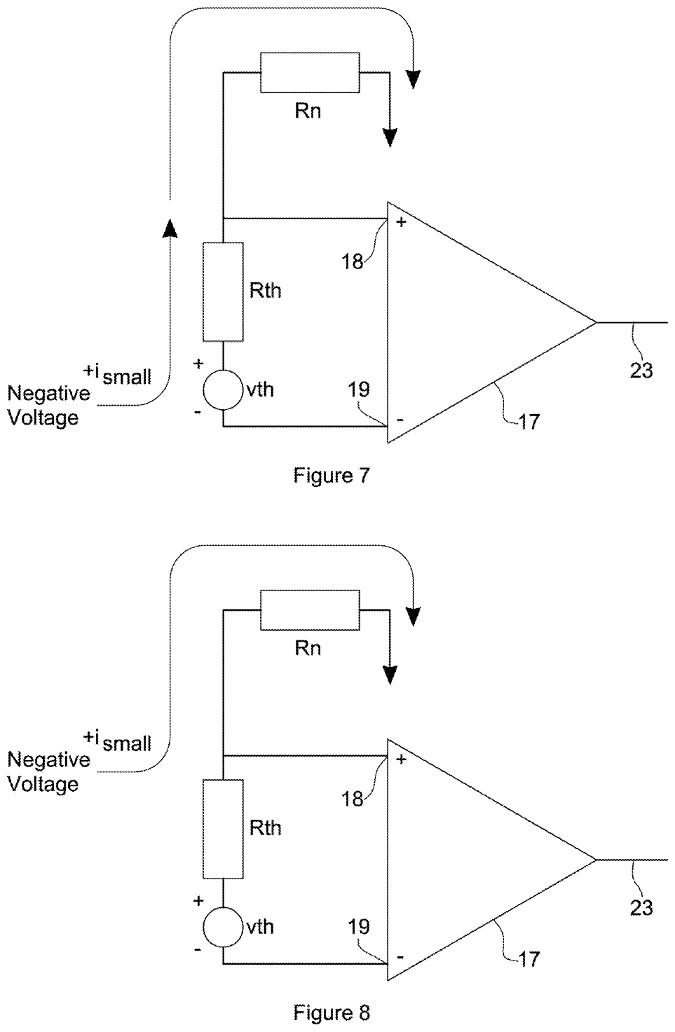

Referring now to FIG. 7, in the event that there is a negative leakage current at the second input terminal 19, a negative voltage is produced. The protection circuit 25 diverts the leakage current iₛₘₐₗₗ by enabling the leakage current iₛₘₐₗₗ to flow through the thermocouple 21, through the first resistor Rₙ and through the first diode Dₙ (not shown) to ground. The diversion of the leakage current iₛₘₐₗₗ in this way causes the differential amplifier 17 to output a high output signal which controls a heater to run at a temperature which is at or lower than the predetermined safe temperature.

FIG. 8 shows a similar operation to FIG. 7, but the leakage current iₛₘₐₗₗ flows in via the first input terminal 18 of the differential amplifier 17. The leakage current iₛₘₐₗₗ is diverted to flow again through the first resistor Rₙ and the first diode Dₙ (not shown) to ground. The diversion of the leakage current iₛₘₐₗₗ in this way ensures that the output from the differential amplifier 17 is unaffected by the leakage current iₛₘₐₗₗ.

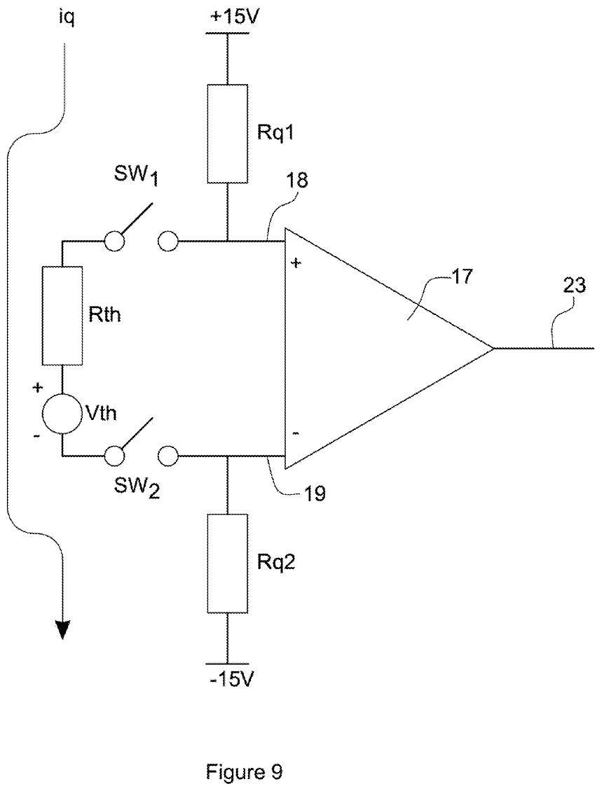

FIG. 9 of the accompanying drawings shows how a small quiescent current i_{q} flows when switches SW₁ and SW₂ are closed (i.e. when thermocouple connected) through the third resistor R_{q1} and the fourth resistor R_{q2}. When either switch SW₁ or SW₂ is open there is no current flow (i_{q}=0) (e.g. in the event that one or both of the first terminal 20 or the second terminal 22 of the thermocouple 21 is disconnected from the input terminals 18, 19). In this third mode of operation, when the quiescent current i_{q} is zero in the event that the thermocouple 21 is disconnected, the differential amplifier 18 outputs a high output temperature sense signal. The high output temperature sense signal causes the heater to switch off to minimise or prevent damage caused by the heater.

The first and second Zener diodes Zₙ, Zₚ ensure that a large current flowing into or out from the protection circuit 25 does not cause the maximum input voltage of the differential amplifier 17 to be exceeded. Depending on the polarity of the large current, the large current produces a voltage which rises until the voltage reaches the breakdown voltage of either the first Zener diode Zₙ (a fifth mode of operation) or the second Zener diode Zₚ (a fourth mode of operation). When the breakdown voltage is reached, either the first Zener diode Zₙ or the second Zener diode Zₚ conducts in the reverse direction to allow the large current to flow to ground (or another voltage within the working range of the differential amplifier). This in turn limits the voltage at the input terminals 18, 19 to close to the breakdown voltage, thereby protecting the differential amplifier 17 from damage by the large current and causing the reported temperature to be higher than the actual temperature so that the heater runs cooler than the requested setpoint.

The range of currents for which the protection circuit 25 is in the first mode (or the second mode) and for which the protection circuit 25 is in the fourth mode 4 (or the fifth mode) will now be discussed since the currents in each mode enable the functionality of the protection circuit 25.

In the first mode (or the second mode) the absolute voltage (with respect to ground) is roughly (excluding the diode drop) proportional to the leakage current (and hence the error in the reported temperature at the output terminal 23). This information can be used to correct the reported temperature, nulling the error and/or allow some useful behaviour at a predetermined leakage current (such as warning the user or notifying them that a part needs replacing).

Once the protection circuit 25 transitions to the fourth mode (or the fifth mode) no further information about the level of leakage is indicated by the voltages at the input terminals 18 and 19, but as previously described the protection circuit 25 can remain safely operational, albeit at lower temperature than the requested setpoint.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

### Representative Features

Representative features are set out in the following clauses, which stand alone or may be combined, in any combination, with one or more features disclosed in the text and/or drawings of the specification.

1. A temperature monitoring system for use with a thermocouple and a heater controller to control a heater, wherein the system comprises:
a differential amplifier which comprises:
   a first input terminal which is configured to connect to a first terminal of the thermocouple;
   a second input terminal which is configured to connect to a second terminal of the thermocouple; and
   an output terminal which is configured to provide a temperature sense signal to the heater controller to control the heater, wherein the differential amplifier is configured to generate the temperature sense signal in response to a difference between a first voltage at the first input terminal and a second voltage at the second input terminal, wherein the system further comprises:
a protection circuit which is connected to the first input terminal and the second input terminal, the protection circuit being configured to operate in:
   a first mode in the event that a leakage current flows into the first input terminal or the second input terminal; and
   a second mode in the event that a leakage current flows out from the first input terminal or the second input terminal,
wherein, in the first mode or the second mode, the protection circuit controls the differential amplifier to output a temperature sense which controls the heater to operate at a temperature at or below a predetermined temperature to reduce the risk of damage being caused by the heater.

2. The system of clause 1, wherein the protection circuit comprises:
a first resistor (Rₙ) and a first diode (Dₙ) which are connected in series, wherein the cathode of the first diode (Dₙ) is towards a positive terminal of the thermocouple; and
a second resistor (Rₚ) and a second diode (Dₚ) which are connected in series, wherein the cathode of the second diode (Dₚ) is towards ground.

3. The system of clause 1 or clause 2, wherein the protection circuit is configured to operate in:
a third mode in the event that at least one of the first input terminal or the second input terminal is electrically disconnected from the thermocouple, wherein in the third mode the protection circuit controls the differential amplifier to output a temperature sense signal which controls the heater to switch off to reduce the risk of damage being caused by the heater.

4. The system of clause 3, wherein the protection circuit comprises:
a third resistor (R_{q1}) comprising a first terminal connected to a positive voltage power rail and a second terminal connected to the first input terminal of the differential amplifier; and
a fourth resistor (R_{q2}) comprising a first terminal connected to the second input terminal of the differential amplifier and a second terminal connected to ground or a negative voltage power rail.

5. The system of any one of the clauses 2 to 4, wherein the protection circuit comprises:
a first Zener diode (Zₙ) connected in parallel with the first resistor (Rₙ) wherein the cathode of the first Zener diode (Zₙ) is away from the positive terminal of the thermocouple.

6. The system of any one of clauses 2 to 5, wherein the protection circuit comprises:
a second Zener diode (Zₚ) connected in parallel with the second resistor (Rₚ) wherein the cathode of the second Zener diode (Zₚ) is away from ground

7. The system of any one of the preceding clauses, wherein the protection circuit is configured to monitor voltages at the first and/or second input terminals with respect to ground and to use the monitored voltages to compensate or null the error, provide a diagnostic current measurement and/or provide a warning signal if the monitored voltages are indicative of a leakage current in excess of a predetermined threshold.

8. An integrated circuit comprising the temperature monitoring system of any one of the preceding clauses.

9. A heating apparatus comprising:
a temperature monitoring system according to any one of clauses 1 to 7;
a heater controller which is connected to the output terminal of the differential amplifier;
a heater which is connected to the heater such that the heater is controlled by the heater controller in response to the temperature sense signal; and
a thermocouple comprising a first terminal which is connected to the first input terminal of the differential amplifier and a second terminal which is connected to the second input terminal of the differential amplifier.

10. The heating apparatus of clause 9, wherein the thermocouple is at least partly received within a recess in the heater, the thermocouple being electrically insulated from the heater by an electrically insulating layer.

11. An electrospray ionisation source comprising the heating apparatus of clause 9 or clause 10.

12. A mass spectrometry system comprising the heating apparatus of clause 9 or clause 10.

1. A temperature monitoring system for use with a thermocouple and a heater controller to control a heater, wherein the system comprises:
a differential amplifier which comprises:
a first input terminal which is configured to connect to a first terminal of the thermocouple;
a second input terminal which is configured to connect to a second terminal of the thermocouple; and
an output terminal which is configured to provide a temperature sense signal to the heater controller to control the heater, wherein the differential amplifier is configured to generate the temperature sense signal in response to a difference between a first voltage at the first input terminal and a second voltage at the second input terminal, wherein the system further comprises:
a protection circuit which is connected to the first input terminal and the second input terminal, the protection circuit being configured to operate in:
a first mode in the event that a leakage current flows into the first input terminal or the second input terminal; and
a second mode in the event that a leakage current flows out from the first input terminal or the second input terminal,
wherein, in the first mode or the second mode, the protection circuit controls the differential amplifier to output a temperature sense which controls the heater to operate at a temperature at or below a predetermined temperature to reduce the risk of damage being caused by the heater.

2. The system of claim 1, wherein the protection circuit comprises:
a first resistor (Rₙ) and a first diode (Dₙ) which are connected in series, wherein the cathode of the first diode (Dₙ) is towards a positive terminal of the thermocouple; and
a second resistor (Rₚ) and a second diode (Dₚ) which are connected in series, wherein the cathode of the second diode (Dₚ) is towards ground.

3. The system of claim 1, wherein the protection circuit is configured to operate in:
a third mode in the event that at least one of the first input terminal or the second input terminal is electrically disconnected from the thermocouple, wherein in the third mode the protection circuit controls the differential amplifier to output a temperature sense signal which controls the heater to switch off to reduce the risk of damage being caused by the heater.

4. The system of claim 3, wherein the protection circuit comprises:
a third resistor (R_{q1}) comprising a first terminal connected to a positive voltage power rail and a second terminal connected to the first input terminal of the differential amplifier; and
a fourth resistor (R_{q2}) comprising a first terminal connected to the second input terminal of the differential amplifier and a second terminal connected to ground or a negative voltage power rail.

5. The system of claim 2, wherein the protection circuit comprises:
a first Zener diode (Zₙ) connected in parallel with the first resistor (Rₙ) wherein the cathode of the first Zener diode (Zₙ) is away from the positive terminal of the thermocouple.

6. The system of claim 2, wherein the protection circuit comprises:
a second Zener diode (Zₚ) connected in parallel with the second resistor (Rₚ) wherein the cathode of the second Zener diode (Zₚ) is away from ground

7. The system of claim 1, wherein the protection circuit is configured to monitor voltages at the first and/or second input terminals with respect to ground and to use the monitored voltages to compensate or null the error, provide a diagnostic current measurement and/or provide a warning signal if the monitored voltages are indicative of a leakage current in excess of a predetermined threshold.

8. An integrated circuit comprising the temperature monitoring system of claim 1.

9. A heating apparatus comprising:
a temperature monitoring system according to claim 1;
a heater controller which is connected to the output terminal of the differential amplifier;
a heater which is connected to the heater such that the heater is controlled by the heater controller in response to the temperature sense signal; and
a thermocouple comprising a first terminal which is connected to the first input terminal of the differential amplifier and a second terminal which is connected to the second input terminal of the differential amplifier.

10. The heating apparatus of claim 9, wherein the thermocouple is at least partly received within a recess in the heater, the thermocouple being electrically insulated from the heater by an electrically insulating layer.

11. An electrospray ionisation source comprising the heating apparatus of claim 9.

12. A mass spectrometry system comprising the heating apparatus of claim 9.
